(19) United States
(12) Patent Application Publication
(10) Pub. No.: US 2010/0266759 A1
(43) Pub. Date: Oct. 21, 2010

(54) CO-CROSSLINKER CONTAINING CARBAMATE GROUPS

(75) Inventors: Carl Jokisch, Mannheim (DE); Rainer Erhardt, Shanghai (CN); Eckhard Korona, Neustadt (DE); Ulrike Mahn, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/158,706

(22) PCT Filed: Dec. 13, 2006
(86) PCT No.: PCT/EP06/69628

§ 371 Date: Jun. 23, 2008

(30) Foreign Application Priority Data
Dec. 23, 2005 (DE) 10 2005 062 379.4

(51) Int. Cl. B05D 3/02; C08K 5/3492

(52) U.S. Cl. 427/180; 524/100

(57) ABSTRACT

The present invention relates to powder coatings which comprise tricarbamoyltriazines modified with carbamate groups.

The present invention relates to powder coatings which comprise tricarbamoyltriazines modified with carbamate groups.

DE 19744561 A1, DE 19841408 A1, and DE 10027293 A1 describe powder coating materials which comprise, in particular, epoxy-containing binders and also alkoxycarbonylaminotriazines as crosslinkers. The disclosure is only of the tris(alkoxycarbonylamino)triazines substituted by alkyl groups.

Derivatizations are not envisioned.

German patent application DE 10 2004 018543 A1 describes triazine derivatives having carbamate end groups.

There is no description of their specific possibilities for application in powder coating materials.

WO 03/025074 (equivalent to U.S. Pat. No. 6,699,942) describes derivatized alkoxycarbonylaminotriazines. An example is given in which a hydroxyethylcarbamate-modified alkoxycarbonylaminotriazine in a powder coating material is described. The powder coating materials thus obtained exhibit good mar resistance. The stoichiometry of the modified alkoxycarbonylaminotriazine, however, is not disclosed, and nor are reaction conditions for the preparation nor analytical data.

As binders, broad lists of polymers are given which can have any of a very wide variety of functional groups, in combination with a variety of curing agents. Explicitly disclosed in the examples and claims is merely an acrylate resin, carrying epoxide groups, with dodecanedicarboxylic acid and also, as a co-crosslinker component, the carbamate-modified alkoxycarbonylaminotriazine of indefinite composition.

A disadvantage of the systems described therein, however, is the high necessary baking temperature of 145° C. Moreover, nothing is said about the degree of functionalization or the preparation of the alkoxycarbonylaminotriazine employed.

It was an object of the present invention to develop coating compositions for powder coating materials which exhibit a lower baking temperature than the systems known from the prior art. At the same time the coating properties, such as solvent resistance and/or adhesion and surface quality of the coatings obtained, for example, ought at least to be retained, if not indeed improved.

This object has been achieved by means of powder coating materials comprising

at least one carboxyl-carrying polyester (A) having a carboxyl group functionality of at least two,

at least one compound (B) having at least two epoxy groups,

if appropriate, at least one compound (C) having at least two hydroxyl groups, and

at least one tricarbamoyltriazine compound (D), comprising carbamate groups, the tricarbamoyltriazine compound (D) having a carbamate functionality of at least 2.0 up to 2.95.

The constituents of the powder coating materials of the invention have been selected in relation to the prior art, in particular in relation to WO 03/025074, in such a way that it has been possible to reduce the baking temperature.

The functionality in respect of a particular functional group means, in the context of the present specification, the statistical average number of functional groups per molecule.

Powder coating materials according to DIN EN 971-1 are pulverulent, solvent-free coating materials which, after being melted and baked, produce a coating.

Carboxyl-carrying polyesters (A) have a carboxyl group functionality of at least two, preferably 2 to 20, more preferably 2 to 15, very preferably 3 to 10, in particular from 3 to 6.

The carboxyl-carrying polyesters (A) are typically synthesized from

at least one diol (A1) having a hydroxyl group functionality of 2,

if appropriate, at least one polyol (A2) having a hydroxyl group functionality of more than 2,

at least one dicarboxylic acid (A3) having a carboxyl group functionality of 2,

if appropriate, at least one polycarboxylic acid (A4) having a carboxyl group functionality of more than 2, and

if appropriate, compounds (A5) which contain at least one hydroxyl and/or carboxyl group and at least one functional group different than hydroxyl and carboxyl groups.

Examples of diols (A1) are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,2-decanediol, 1,10-decanediol, 1,2-dodecanediol, 1,12-dodecanediol, 1,5-hexadiene-3,4-diol, 1,2- and 1,3-cyclopentanediols, 1,2-, 1,3-, and 1,4-cyclohexanediols, 1,1-, 1,2-, 1,3-, and 1,4-bis(hydroxymethyl)cyclohexanes, 1,1-, 1,2-, 1,3- and 1,4-bis(hydroxyethyl)cyclohexanes, neopentyl glycol, (2)-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H, n being an integer and being ≧4, polyethylenepolypropylene glycols, it being possible for the sequence of the ethylene oxide or propylene oxide units to be clockwise or random, polytetramethylene glycols, preferably up to a molar weight up to 5000 g/mol, poly-1,3-propanediols, preferably with a molar weight up to 5000 g/mol, polycaprolactones, or mixtures of two or more representatives of the aforementioned compounds. Either one or both hydroxyl groups in the above-mentioned diols can be substituted by SH groups. Diols whose use is preferred are ethylene glycol, 1,2-propanediol, 1,3-propanediol, 1,4-butanediol, 1,5-pentanediol, 1,6-hexanediol, 1,8-octanediol, 1,2-, 1,3-, and 1,4-cyclohexanediol, 1,3- and 1,4-bis(hydroxymethyl)cyclohexane, and also diethylene glycol, triethylene glycol, dipropylene glycol, and tripropylene glycol.

Examples of polyols (A2) are glycerol, trimethylolmethane, trimethylolethane, trimethyllolpropane, 1,2,4-butanetriol, tris(hydroxymethyl)amine, tris(hydroxyethyl)amine, tris(hydroxypropyl)amine, pentaerythritol, diglycerol, triglycerol or higher condensation products of glycerol, di(trimethylolpropane), di(pentaerythritol), trishydroxymethyl isocyanurate, tris(hydroxyethyl) isocyanurate (THEIC), tris(hydroxypropyl) isocyanurate, inositols or sugars, such as, for example, glucose, fructose or sucrose, sugar alcohols such as, for example, sorbitol, mannitol, threitol, erythritol, adonitol (ribitol), arabitol (lyxitol), xylitol, dulcitol (galactol), maltitol, isomalt, polyetherols having a functionality of three or more and based on alcohols having a functionality of three or more and on ethylene oxide, propylene oxide and/or butylene oxide.

Particular preference is given here to glycerol, diglycerol, triglycerol, trimethylolethane, trimethylolpropane, 1,2,4-butanetriol, pentaerythritol, tris(hydroxyethyl) isocyanurate, and their polyetherols based on ethylene oxide and/or propylene oxide.

The dicarboxylic acids (A3) include, for example, aliphatic dicarboxylic acids, such as oxalic acid, malonic acid, succinic acid, glutaric acid, adipic acid, pimelic acid, suberic acid, azaleic acid, sebacic acid, undecane-α,ω-dicarboxylic acid, dodecane-amdicarboxylic acid, cis- and trans-cyclohexane-1,2-dicarboxylic acid, cis- and transcyclohexane-1,3-dicarboxylic acid, cis- and trans-cyclohexane-1,4-dicarboxylic acid, cis- and trans-cyclopentane-1,2-dicarboxylic acid, and cis- and trans-cyclopentane-1,3-dicarboxylic acid. In addition it is also possible to use aromatic dicarboxylic acids, such as phthalic acid, isophthalic acid or terephthalic acid, for example. Unsaturated dicarboxylic acids too, such as maleic acid or fumaric acid, can be employed.

The stated dicarboxylic acids can also be substituted by one or more radicals selected from

C₁-C₁₀ alkyl groups, examples being methyl, ethyl, n-propyl, iso-propyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, trimethylpentyl, n-nonyl or n-decyl,
C₃-C₁₂ cycloalkyl groups, examples being cyclopropyl, cyclobutyl, cyclopentyl, cyclohexyl, cycloheptyl, cyclooctyl, cyclononyl, cyclodecyl, cycloundecyl and cyclododecyl; preferably cyclopentyl, cyclohexyl, and cycloheptyl;
alkylene groups such as methylene or ethylidene, or
C₆-C₁₄ aryl groups such as, for example, phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, preferably phenyl, 1-naphthyl, and 2-naphthyl, more preferably phenyl.

As exemplary representatives of substituted dicarboxylic acids mention may be made of the following: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

In addition it is possible to use mixtures of two or more of the aforementioned dicarboxylic acids.

The dicarboxylic acids can be used either as they are or in the form of derivatives.

By derivatives are meant preferably
the relevant anhydrides in monomeric or else polymeric form,
monoalkyl or dialkyl esters, preferably mono- or di-C₁-C₄ alkyl esters, more preferably monomethyl or dimethyl esters or the corresponding monoethyl or diethyl esters,
furthermore, monovinyl and divinyl esters, and also
mixed esters, preferably mixed esters with different C₁-C₄ alkyl components, more preferably mixed methyl ethyl esters.

C₁-C₄ alkyl for the purposes of this specification is methyl, ethyl, isopropyl, n-propyl, n-butyl, isobutyl, sec-butyl, and tert-butyl, preferably methyl, ethyl, and n-butyl, more preferably methyl and ethyl, and very preferably methyl.

In the context of the present invention it is also possible to use a mixture of a dicarboxylic acid and one or more of its derivatives. It is equally possible within the context of the present invention to use a mixture of two or more different derivatives of one or more dicarboxylic acids.

Particular preference is given to using malonic acid, succinic acid, glutaric acid, adipic acid, 1,2-, 1,3- or 1,4-cyclohexanedicarboxylic acid (hexahydrophthalic acids), phthalic acid, isophthalic acid, terephthalic acid or their monoalkyl or dialkyl esters.

Polycarboxylic acids (A4) are, for example, aconitic acid, 1,3,5-cyclohexanetricarboxylic acid, 1,2,4-benzenetricarboxylic acid, 1,3,5-benzenetricarboxylic acid, 1,2,4,5-benzenetetracarboxylic acid (pyromellitic acid), and also mellitic acid and low molecular mass polyacrylic acids.

Tricarboxylic acids or polycarboxylic acids (A4) can be employed in the reaction of the invention either per se or in the form of derivatives.

By derivatives are meant preferably
the relevant anhydrides in monomeric or else polymeric form,
monoalkyl, dialkyl or trialkyl esters, preferably mono-, di or tri-C₁-C₄ alkyl esters, more preferably monomethyl, dimethyl or trimethyl esters or the corresponding monoethyl, diethyl or triethyl esters,
furthermore, monovinyl, divinyl and trivinyl esters, and also
mixed esters, preferably mixed esters with different C₁-C₄ alkyl components, more preferably mixed methyl ethyl esters.
   In the context of the present invention it is also possible to use a mixture of a tricarboxylic or polycarboxylic acid and one or more of its derivatives, a mixture of pyromellitic acid and pyromellitic dianhydride for example. It is equally possible in the context of the present invention to use a mixture of two or more different derivatives of one or more tricarboxylic or polycarboxylic acids, a mixture of 1,3,5-cyclohexanetricarboxylic acid and pyromellitic dianhydride, for example.

Compounds (A5) have not only hydroxyl and/or carboxyl groups but also at least one further functionality, such as comprise carbonyl, alkoxycarbonyl or sulfonyl, for example, such as dimethylolpropionic acid or dimethylolbutyric acid, for example, and also their C₁-C₄ alkyl esters.

The preparation of carboxyl-carrying polyesters (A) is known to the skilled worker and is not essential to the invention.

It is critical that the carboxyl-carrying polyesters (A) have a carboxyl functionality of at least 2.

Preferred carboxyl-carrying polyesters (A) are solid at room temperature (23° C.); particularly preferred polyesters (A) have a melting point of at least 55° C., very preferably of 70° C. The polyesters (A) must, however, have a melting point below the baking temperature.

The viscosity to ISO 3219 of the polyesters (A) in the melt at 175° C. is between 50 and 20 000 mPas, preferably 100-15 000 mPas.

Th carboxyl-carrying polyesters (A) generally have a glass transition temperature of at least 40° C., preferably at least 45° C., and more preferably at least 50° C.

The glass transition temperature, T₉, is determined by the DSC (differential scanning calorimetry) method in accordance with ASTM 3418/82; the heating rate is preferably 10° C./min.

Preferred carboxyl-carrying polyesters (A) possess an OH number to DIN 53240, Part 2 (potentiometric) of 0 up to 100 mg KOH/g, preferably 1 to 50, more preferably 2 to 25, and very preferably from 2.5 to 10 mg KOH/g.

In addition, the carboxyl-carrying polyesters (A) have an acid number to DIN 53240, Part 2 (potentiometric) of more than 0 to 250 mg KOH/g, preferably 5 to 150, more preferably below 10 to 100, and very preferably 40 to 100 mg KOH/g.

The carboxyl-carrying polyesters (A) employed with preference have a number-average molecular weight Mₙ of at least 500, preferably at least 600, and more preferably 750 g/mol. The upper limit of the molecular weight Mₙ is preferably 100 000 g/mol; with particular preference it is not more than 80 000 and with very particular preference not more than 30 000 g/mol.

Compounds (B) carry at least 2, preferably 2-20, more preferably 2-15, very preferably 2-10, and in particular 2-6 epoxy groups.

Preferably they have a molar weight below 20 000 g/mol, more preferably below 15 000 g/mol, very preferably below 10 000 g/mol, in particular below 5000, and especially below 2000 g/mol.

Examples of compounds (B) are glycidyl ethers of aliphatic or aromatic polyols. Products of this kind are available in large numbers in commerce.

Examples of aromatic glycidyl ethers are bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene) (CAS No. [13446-85-0]), tris[4-(2,3-epoxypropoxy)phenyl]methane isomers (CAS No. [66072-39-7]), phenol-based epoxy novolaks (CAS No. [9003-35-4]), and cresol-based epoxy novolaks (CAS No. [37382-79-9]).

Examples of aliphatic glycidyl ethers are 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ethers of polypropylene glycol (α,ω-bis(2,3-epoxypropoxy)poly(oxypropylene) (CAS No. [16096-30-3]) and of hydrogenated bisphenol A (2,2-bis[4-(2,3-epoxypropoxy)cyclohexyl]propane, CAS No. [13410-58-7]).

Particular preference is given to polyglycidyl compounds of the bisphenol A, F or B type, their fully hydrogenated derivatives, and glycidyl ethers of polyhydric alcohols, such as of 1,4-butanediol, 1,4-cyclohexanedimethanol, neopentyl glycol, of 1,6-hexanediol, of glycerol, trimethylolpropane, and of pentaerythritol. Examples of polyepoxide compounds of this kind are Epikote® 1001, Epikote® 1007, and Epikote® 162 (epoxide value: about 0.61 mol/100 g) from Resolution, Rütapox® 0162 (epoxide value: about 0.58 mol/100 g) from Hexion, and Araldit® DY 0397 (epoxide value: about 0.83 mol/100 g) and Araldit® GT 6063 (0.14 mol/100 g) from Huntsman (formerly Vantico AG).

Very particular preference is given to bisphenol A diglycidyl ether, 1,4-butanediol diglycidyl ether, trimethylolpropane triglycidyl ether, and pentaerythritol tetraglycidyl ether, especially bisphenol A diglycidyl ether.

Compounds other than ethers are also conceivable, examples being esters of dicarboxylic and polycarboxylic acids, such as, for example, phthalic esters and terephthalic esters, with glycidol, and also triglycidyl isocyanurate.

The compounds (B) preferably have a minimum melting point of 50° C., preferably at least 65° C., and more preferably at least 85° C.

The compound (B) preferably has an epoxide number of 0.1 to 10 equivalents/kg, preferably 0.5 to 8, more preferably 1-7 equivalents/kg.

The melting point ought in general not to exceed 120° C. The compounds (B) must, however, have a melting point below the baking temperature.

The melt viscosity of (B) at 175° C. to ISO 3219 ought to be 50-5000 mPas, preferably 100-3000 mPas, very preferably 200-700 mPas.

Compounds (C) are compounds having at least two hydroxyl groups, 2-20 for example, preferably 2-15, more preferably 2-10, very preferably 2-6, and in particular 2-4.

Examples of such compounds (C) are polyacrylate polyols, polyester polyols, polyether polyols, polyurethane polyols; polyurea polyols; polyester-polyacrylate polyols; polyester-polyurethane polyols; polyurethane-polyacrylate polyols, polyurethane-modified alkyd resins; fatty acid-modified polyester-polyurethane polyols, copolymers with allyl ethers, graft polymers of the stated classes of compound with, for example, different glass transition temperatures, and also mixtures of the mentioned binders. Preference is given to polyacrylate polyols, polyester polyols, and polyether polyols.

It is preferred to use polyacrylate polyols, polyesterols and/or polyetherols, more preferably those having a molecular weight Mₙ of at least 1000 g/mol.

The polyacrylate polyols are for example those comprising hydroxyl-carrying monomers in copolymerized form, preferably 2-hydroxyethyl acrylate, 2-hydroxyethyl methacrylate, 2- or 3-hydroxypropyl acrylate, 1,4-butanediol monoacrylate or 3-(acryloyloxy)-2-hydroxypropyl acrylate, and more preferably 2-hydroxyethyl acrylate and/or 2-hydroxyethyl methacrylate, usually in a mixture with other polymerizable, preferably free-radically polymerizable monomers, preferably those composed of more than 50% by weight of C₁-C₂₀ alkyl (meth)acrylate, vinylaromatics having up to 20 carbon atoms, vinyl esters of carboxylic acids comprising up to 20 carbon atoms, vinyl halides, nonaromatic hydrocarbons having 4 to 8 carbon atoms and 1 or 2 double bonds, unsaturated nitriles, and mixtures thereof. Particular preference is given to the polymers composed of more than 60% by weight of C₁-C₁₀ alkyl (meth)acrylates, styrene or mixtures thereof.

The polymers may further comprise hydroxy-functional monomers corresponding to the above hydroxyl group content and, if appropriate, further monomers, examples being ethylenically unsaturated acids, especially carboxylic acids, acid anhydrides or acid amides.

Further polymers are, for example, polyesterols, as are obtainable by condensing polycarboxylic acids, especially dicarboxylic acids, with polyols, especially diols.

Polyester polyols are known for example from Ullmanns Encyklopadie der technischen Chemie, 4th edition, Volume 19, pp. 62 to 65. It is preferred to use polyester polyols obtained by reacting dihydric alcohols with dibasic carboxylic acids. In lieu of the free polycarboxylic acids it is also possible to use the corresponding polycarboxylic anhydrides or corresponding polycarboxylic esters of lower alcohols, or mixtures thereof, to prepare the polyester polyols. The polycarboxylic acids may be aliphatic, cycloaliphatic, araliphatic, aromatic or heterocyclic and may if appropriate be substituted, by halogen atoms, for example, and/or unsaturated. Examples that may be mentioned thereof include the following:

oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, isomers thereof and hydrogenation products thereof, and esterifiable derivatives, such as anhydrides or dialkyl esters, examples being C₁-C₄ alkyl esters, preferably methyl, ethyl or n-butyl esters, of said acids. Preference is given to dicarboxylic acids of the general formula HOOC—(CH₂)_{y}—COOH, y being a number from 1 to 20, preferably an even number from 2 to 20, and particular preference to succinic acid, adipic acid, sebacic acid, and dodecanedicarboxylic acid.

Suitable polyhydric alcohols for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, poly-THF having a molar mass of between 162 and 2000, poly-1,3-propanediol having a molar mass of between 134 and 117.8, poly-1,2-propanediol having a molar mass of between 134 and 898, polyethylene glycol having a molar mass of between 106 and 458, neopentyl glycol, neopentyl glycol hydroxypivalate, 2-ethyl-1,3-propanediol, 2-methyl-1,3-propanediol, 2,2-bis(4-hydroxycyclohexyl)propane, 1,1-, 1,2-, 1,3-, and 1,4-cyclohexanedimethanol, 1,2-, 1,3- or 1,4-cyclohexanediol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which can be alkoxylated as described above, if appropriate.

Preference is given to alcohols of the general formula HO—(CH₂)ₓ(CH₂)ₓ—OH, x being a number from 1 to 20, preferably an even number from 2 to 20. Preference is given to ethylene glycol, butane-1,4-diol, hexane-1,6-diol, octane-1,8-diol, and dodecane-1,12-diol. Preference is further given to neopentyl glycol.

Further, suitability is also possessed by polycarbonate diols, such as may be obtained by reacting phosgene with an excess of the low molecular mass alcohols specified as structural components for the polyester polyols.

Also suitable are lactone-based polyester diols, which are homopolymers or copolymers of lactones, preferably hydroxyl-terminated adducts of lactones with suitable difunctional starter molecules. Suitable lactones include preferably those derived from compounds of the general formula HO—(CH₂)_{z}—COON, z being a number from 1 to 20 and it also being possible for one H atom of a methylene unit to have been substituted by a C₁ to C₄ alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone, and mixtures thereof. Suitable starter components are, for example, the low molecular mass dihydric alcohols specified above as a structural component for the polyester polyols. The corresponding polymers of ε-caprolactone are particularly preferred. Lower polyester diols or polyether diols as well can be used as starters for preparing the lactone polymers. In lieu of the polymers of lactones it is also possible to use the corresponding, chemically equivalent polycondensates of the hydroxy carboxylic acids corresponding to the lactones.

Additionally suitable as polymers are polyetherols, which are prepared by addition reaction of ethylene oxide, propylene oxide or butylene oxide with H-active components. Also suitable are polycondensates of butanediol.

The polymers can of course also be compounds having primary or secondary amino groups.

Preferred compounds (C) have a molecular weight Mₙ of at least 1000, more preferably at least 2000, and very preferably 5000. The molecular weight Mₙ can for example be up to 200 000, preferably up to 100 000, more preferably up to 80 000, and very preferably up to 50 000 g/mol.

Besides these stated polymeric compounds the hydroxyl-carrying compound (C) may also comprise low molecular mass compounds, i.e., those having a molecular weight below 1000 g/mol.

These are, for example, hydroxyalkylated amides of dicarboxylic or polycarboxylic acids, preferably the amides of dicarboxylic or polycarboxylic acids with diethanolamine or dipropanolamine.

Examples thereof are N,N,N′,N′-tetrakis(2-hydroxyethyl)adipamide and N,N,N′,N′-tetrakis(2-hydroxypropyl)adipamide.

Preferably the compounds (C) have a minimum melting point of 50° C., preferably at least 60° C., and more preferably at least 70° C.

In general the melting point ought not to exceed 120° C. The compounds (C) must, however, have a melting point below the baking temperature.

Preferred compounds (C) possess an OH number to DIN 53240, Part 2 (potentiometric) of at least 10 up to 500 mg KOH/g, preferably 20 to 300 mg KOH/g.

In addition the compounds (C) have an acid number to DIN 53240, Part 2 (potentiometric) of 0 to 50 mg KOH/g, preferably 0 to 20, and more preferably below 10.

Comprised essentially in accordance with the invention in the powder coating materials is at least one tricarbamoyltriazine compound (D) which comprises carbamate groups, the tricarbamoyltriazine compound (D) having a carbamate functionality of at least 2.0 up to 2.95.

By a tricarbamoyltriazine compound is meant in this context a compound which, formally, is constructed of a melamine ((C₃N₃)(NH₂)₃) on each of whose three amino groups a hydrogen atom has been replaced by a urethane group, in other words an arbitrarily O-substituted carboxyl group. Also possible are what are called polycyclic compounds, constructed formally from more than one triazine molecule, from 2 or 3, for example, the triazine molecules of which are joined to one another. In that case, correspondingly, a hydrogen atom on each of the free amino groups is replaced by an arbitrarily O-substituted carboxyl group.

A carbamate group is an end group —(CO)—NH₂ or —(CO)—NHR, in which R may comprise the definitions of R², R³ or R⁴ (see below).

The carbamate functionality of the compounds (D) is in accordance with the invention from 2.0 to 2.95. Preferably the carbamate functionality is at least 2.1, more preferably at least 2.2, very preferably at least 2.3, and in particular at least 2.4. The carbamate functionality is preferably up to 2.9, more preferably up to 2.8, very preferably up to 2.7, and in particular up to 2.6.

The compound (D) is preferably composed predominantly of a mixture of compounds (D1)

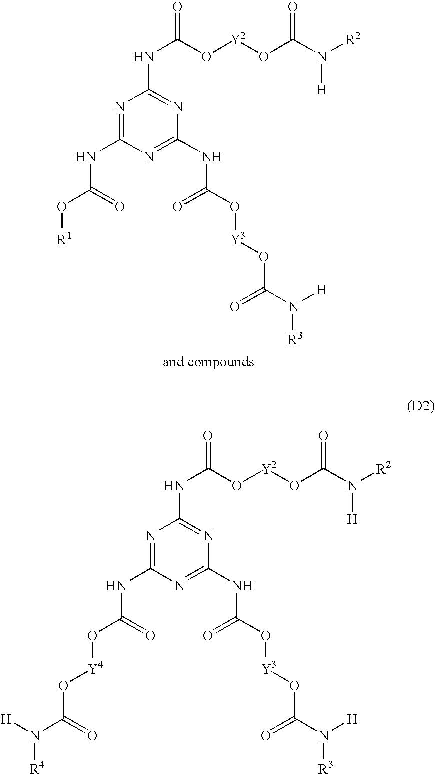

in which
R¹, R², R³, and R⁴ each independently are C₁-C₁₈ alkyl, C₆-C₁₂ aryl or C₅-C₁₂ cycloalkyl,
R², R³, and R⁴ are additionally hydrogen, and
Y², Y³, and Y⁴ each independently are C₂-C₂₀ alkylene, C₅-C₁₂ cycloalkylene, or C₂-C₂₀ alkylene interrupted by one or more oxygen and/or sulfur atoms and/or by one or more substituted or unsubstituted imino groups and/or by one or more cycloalkyl, —(CO)—, —O(CO)O—, —(NH)(CO)O—, —O(CO)(NH)—, —O(CO)— or —(CO)O— groups, it being possible for the stated radicals each to be substituted by aryl, alkyl, aryloxy, alkyloxy, heteroatoms and/or heterocycles.

Examples of R¹, R², R³, and R⁴ are C₁ to C₄ alkyl, which in this specification stands for methyl, ethyl, isopropyl, n-propyl, n-butyl, isobutyl, sec-butyl or tent-butyl, n-hexyl, n-heptyl, n-octyl, n-decyl, n-dodecyl, n-tetradecyl, n-hexadecyl, n-octadecyl, n-eicosyl, 2-ethylhexyl, cyclopentyl, cyclohexyl, cyclooctyl or cyclododecyl, and, for R², R³, and R⁴, additionally for hydrogen.

R¹ is preferably methyl, ethyl, isopropyl, n-propyl, n-butyl, isobutyl or sec-butyl, preferably methyl, ethyl, n-butyl, very preferably methyl and n-butyl, and especially methyl.

R², R³, and R⁴ are preferably hydrogen.

Examples of Y², Y³, and Y⁴ are, each independently, 1,2-ethylene, 1,2-propylene, 1,1-dimethyl-1,2-ethylene, 1-hydroxymethyl-1,2-ethylene, 2-hydroxy-1,3-propylene, 1,3-propylene, 1,4-butylene, 1,6-hexylene, 2-methyl-1,3-propylene, 2-ethyl-1,3-propylene, 2,2-dimethyl-1,3-propylene, and 2,2-dimethyl-1,4-butylene, or

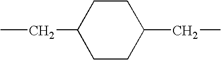

or 1,2-, 1,3- or 1,4-cyclohexylene,
preferably 1,2-ethylene, 1,2-propylene or 1,3-propylene, more preferably 1,2-ethylene and 1,2-propylene, and very preferably 1,2-ethylene.

With particular preference the radicals R², R³, and R⁴ and also the radicals Y², Y³, and

Y⁴ are each the same.

The compounds (D) are composed in general of at least 60% by weight in total of compounds (D1) and (D2), preferably of at least 70%, more preferably of at least 80%, and with particular preference of at least 90% by weight.

The remainder of compounds (D), those that are not (D1) or (D2), are frequently compounds which carry only one carbamate group, preferably in the form of a moiety —(CO)—O—(Y²—O—(CO)—NHR² on one amino group on the triazine ring, and/or compounds which carry at least one unsubstituted NH₂ group on the triazine ring, and/or those compounds which carry no carbamate group but in which, instead, all three amino groups on the triazine ring are alkoxycarbonyl groups —COOR¹.

The amount of the latter, tris-alkoxycarbonyl-functional compounds in the compounds (D) is generally less than 20%, preferably less than 10%, and very preferably less than 5% by weight.

The powder coating materials of the invention may further comprise

(E) pigments and fillers, and
(F) additives.

Pigments and fillers (E) are for example as follows:

Pigments is used comprehensively for the purposes of this specification for pigments in the true sense, dyes and/or fillers, preferably for pigments in the true sense and fillers, and more preferably for pigments in the true sense.

Pigments in the true sense are, according to CD Römpp Chemie Lexikon—Version 1.0, Stuttgart/New York: Georg Thieme Verlag 1995, with reference to DIN 55943, particulate “organic or inorganic, chromatic or achromatic colorants which are virtually insoluble in the application medium”.

Virtually insoluble here means a solubility at 25° C. of less than 1 g/1000 g of application medium, preferably below 0.5, more preferably below 0.25, very preferably below 0.1 and in particular below 0.05 g/1000 g of application medium.

Examples of pigments in the true sense comprise any desired systems of absorption pigments and/or effect pigments, preferably absorption pigments. The number and selection of the pigment components are not subject to any restrictions whatsoever. They may be adapted to the particular requirements, such as the desired color impression, for example, in an arbitrary way, for example as described in step a). By way of example it is possible for all of the pigment components of a standardized paint mixer system to be taken as the basis.

By effect pigments are meant all pigments which exhibit a platelet-shaped construction and impart specific decorative color effects to a surface coating. The effect pigments are, for example, all of the effect-imparting pigments which can be employed commonly in vehicle finishing and industrial coating. Examples of effect pigments of this kind are pure metal pigments, such as, for example, aluminum, iron or copper pigments; interference pigments, such as titanium dioxide-coated mica, iron oxide-coated mica, mixed oxide-coated mica (e.g., with titanium dioxide and Fe₂O₃ or titanium dioxide and Cr₂C₃), metal oxide-coated aluminum, or liquid-crystal pigments.

The color-imparting absorption pigments are, for example, customary organic or inorganic absorption pigments which can be used in the paint industry. Examples of organic absorption pigments are azo pigments, phthalocyanine pigments, quinacridone pigments and pyrrolopyrrole pigments. Examples of inorganic absorption pigments are iron oxide pigments, titanium dioxide and carbon black.

Dyes are likewise colorants and differ from the pigments in their solubility in the application medium, i.e., they have a solubility at 25° C. of more than 1 g/1000 g in the application medium.

Examples of dyes are azo, azine, anthraquinone, acridine, cyanine, oxazine, polymethine, thiazine and triarylmethane dyes. These dyes can be employed as basic or cationic dyes, mordant dyes, direct dyes, disperse dyes, ingrain dyes, vat dyes, metal complex dyes, reactive dyes, acid dyes, sulfur dyes, coupling dyes or substantive dyes.

Coloristically inert fillers are all substances/compounds which on the one hand are coloristically inactive—that is, they exhibit little intrinsic absorption and have a refractive index similar to that of the coating medium—and on the other hand are capable of influencing the orientation (parallel alignment) of the effect pigments in the surface coating, i.e., in the applied paint film, and also properties of the coating or of the coating compositions, such as hardness or rheology. Inert substances/compounds which can be used are given by way of example below, but without restricting the concept of coloristically inert, topology-influencing fillers to these examples. Suitable inert fillers meeting the definition may be, for example, transparent or semitransparent fillers or pigments, such as silica gels, blanc fixe, kieselguhr, talc, calcium carbonates, kaolin, barium sulfate, magnesium silicate, aluminum silicate, crystalline silicon dioxide, amorphous silica, aluminum oxide, microspheres or hollow microspheres made, for example, from glass, ceramic or polymers and having sizes of for example 0.1-50 μm. Additionally as inert fillers it is possible to employ any desired solid inert organic particles, such as urea-formaldehyde condensates, micronized polyolefin wax and micronized amide wax, for example. The inert fillers can in each case also be used in a mixture. It is preferred, however, to use only one filler in each case.

Examples of additives (F) are catalysts and auxiliaries, such as degassing agents, for example, such as benzoin; flow control agents, UV absorbers, free-radical scavengers and/or antioxidants.

Preferred powder coating materials of the invention have the following composition:
(A) 10% to 75% by weight, preferably 15% to 60%, more preferably 20% to 50%, very preferably 25% to 40%, and in particular 30% to 40% by weight,
(B) 10% to 75% by weight, preferably 15% to 60%, more preferably 20% to 50%, very preferably 25% to 40%, and in particular 30% to 40% by weight,
(C) 0 to 10% by weight, preferably 0 to 8%, more preferably 0.5% to 5%, very preferably 1.5% to 5% by weight,
(D) 1% to 20%, preferably 1% to 15%, more preferably 1% to 10%, very preferably 2% to 7% by weight,
(E) 0 to 70% by weight, preferably 10% to 50%, more preferably 20% to 40%, very preferably 25% to 35% by weight,
(F) 0 to 10% by weight, preferably 1% to 8%, more preferably 1% to 6%, and very preferably 1.5% to 5% by weight,
   with the proviso that the sum of all the components is 100% by weight.

In accordance with the invention it is of advantage if the minimum film-forming temperature of components (A) to (D) is at least 50° C., preferably at least 60° C., more preferably at least 75° C., very preferably at least 85° C., and in particular at least 100° C. The minimum film-forming temperature can be determined by drawing down the mixture under investigation onto a glass plate, using a doctor blade, or applying a finely divided powder to a glass plate and heating it in a gradient oven. The temperature at which the powdery layer films is termed the minimum film-forming temperature.

The average particle size of the finely divided dimensionally stable constituents of the powder coating materials of the invention is preferably 0.5 to 40 μm, more preferably 0.5 to 20 μm, and very preferably 2 to 6 μm. By average particle size is meant the 50% median value as determined by the laser diffraction method, i.e., 50% of the particles have a diameter up to the median value and 50% of the particles have a diameter above the median value. Generally speaking, the particle size of the finely divided dimensionally stable constituents reaches its upper limit when the particles, owing to their size, are no longer able to flow out fully in the course of baking, with a consequent adverse effect on film flow. As an upper limit, 80 μm are considered sensible, since above that particle size there is a likelihood of clogging of the rinsing ducts of the highly sensitive application apparatus.

The preparation of the powder coating materials of the invention has no methodological peculiarities but instead takes place in the way which is known per se to the skilled worker. A preferred preparation procedure involves homogenizing and dispersing, using an extruder or screw compounder, for example, and grinding of the constituents described above. After the powder coating materials of the invention have been prepared they are made ready for application or for dispersion, for the purposes of preparation of the powder coating materials of the invention, by means of further grinding and, if appropriate, by means of screening and sieving.

In one preferred embodiment the powder coating materials of the invention are prepared as follows:

The individual components are combined in a charging vessel and are subjected to intensive physical premixing and prefractionating in, for example, tumble mixers, plow-share mixers, Henschel mixers or overhead mixers.

The premix thus obtained is preferably melted in an extruder at an elevated temperature, 80-120° C. for example, and its components then come into very intimate contact with one another as a result of the mixing and kneading elements. This operation is accompanied by intense commixing of the raw materials: fillers are coated with binders, pigments are dispersed and finely divided, binders and curing agents are brought into close contact. Specifically this contact is necessary in order to achieve effective film formation subsequently, when the powder coating material is baked.

The melt-homogenized mixture leaves the extruder in general at about 100° C. and must be cooled very rapidly to room temperature, in order as far as possible to prevent premature reaction of the now thermoreactive material. For this purpose, the extrudate is often rolled out to a thin strip of material on chilled rolls, transferred to cooling belts, and cooled there to room temperature within a period of less than a minute. The material is then prefractionated to form chips, in order to ensure optimum metering for the next step of operation.

The powder coating chips are then ground to the finished powder coating material in classifier mills, in accordance with the principle of impact comminution. The target particle size to DIN 55990-2 is between 10 and 150 μm, if possible between 30 and 70 μm. If appropriate, in addition, a sieving step is needed for the removal of oversize and/or undersize particles.

The present invention further provides a method of coating articles by applying a powder coating material of the invention to an article in any way and baking it at a substrate temperature below 145° C., preferably up to 140° C., more preferably up to 135° C., and very preferably up to 130° C., over a holding time of 20 minutes to DIN 55990-4. The substrate temperature ought to be at least 100° C., preferably 110° C., more preferably at least 120° C., and very preferably at least 125° C.

The substrate temperature is the temperature which the coated article must attain in the baking oven in order for there to be complete crosslinking of the binder in the coating film. The substrate temperature is reached only after a defined preheating time, and is generally lower than the temperature of the circulating air. The substrate temperature is usually measured by means of thermocouples on specimens in the course of the oven.

The threshold temperature, in other words the minimum temperature or else onset temperature, i.e., the temperature at which the chemical crosslinking of the baking materials of the invention begins, is generally about 10 to 20° C. less than the baking temperature, i.e., the temperature needed for full curing of the powder coating materials in a defined baking time. The powder coating materials of the invention are generally insensitive to overbaking.

The powder coating materials of the invention are used principally in automotive finishing, in the painting of building components, both interior and exterior, in the industrial coating of furniture, doors, and windows, including coil coating and container coating; in all of these technical fields, customary and known substrates of metal, glass and/or wood come into consideration, preference being given to the electrically conductive substrates.

In particular, metallic substrates are coated with the powder coating materials of the invention, examples being surfaces of iron, steel, Zn, Zn alloys, Al or Al alloys. The surfaces may be uncoated, may have been coated with zinc, aluminum or alloys thereof, or may have been hot-dip galvanized, zincked by electroplating, sherardized, or precoated with primers.

### EXAMPLES

Carbamate-modified tris(alkoxycarbonyl)aminotriazine was obtained by heating 250 g of tris(alkoxycarbonyl)aminotriazine having mixed butylation and methylation in a 3:1 ratio, with 273 g of hydroxyethylcarbamate in 250 ml of N-methylpyrrolidone (NMP) at 100° C. for 16 h under a pressure of 30 mbar in a distillation apparatus.

The solvent was removed by distillation under reduced pressure and the product was washed with water.

HPLC analysis on this product (product 1) revealed that it comprised less than 2% of unreacted tris(alkoxycarbonyl)aminotriazine and comprised on average about 2.5 carbamate functionalities (—OCONH₂) per molecule.

The resultant product (product 1) was then used in powder coating compositions:

The baking temperature of the powder coating materials of the invention (example 1) was varied with a holding time of 20 minutes and compared with a polyester powder coating system with epoxide crosslinker, without carbamate-functional tris(alkoxycarbonyl)aminotriazine, as comparison (comparative example 1).

To evaluate the quality of the coating obtained, a measurement was made of how many times it was possible to hand-rub a cloth soaked with methyl ethyl ketone (MEK) over the film before the first traces of dissolution became apparent (MEK test). With a baking temperature of 130° C., this was the case after about 30 double rubs for the comparative example, whereas for the coating material of the invention it was possible to perform more than 100 double rubs for the same baking temperature.

The inventive powder coating material of example 1 therefore, even with a lower baking temperature, exhibited higher solvent resistance than a polyester-based powder coating material (comparative example 1).

For the cross-cut the film is cut in a diamond formation and the adhesion of the coating material to the substrate is evaluated (DIN 53151; the result is reported in grades. Low values denote high adhesion). Here, the comparative example and the inventive coating were approximately comparable.

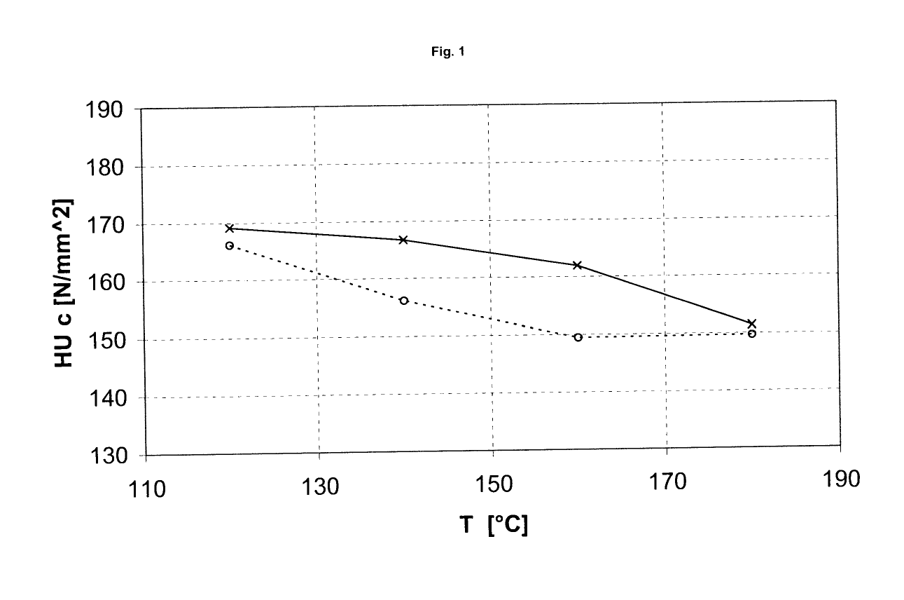

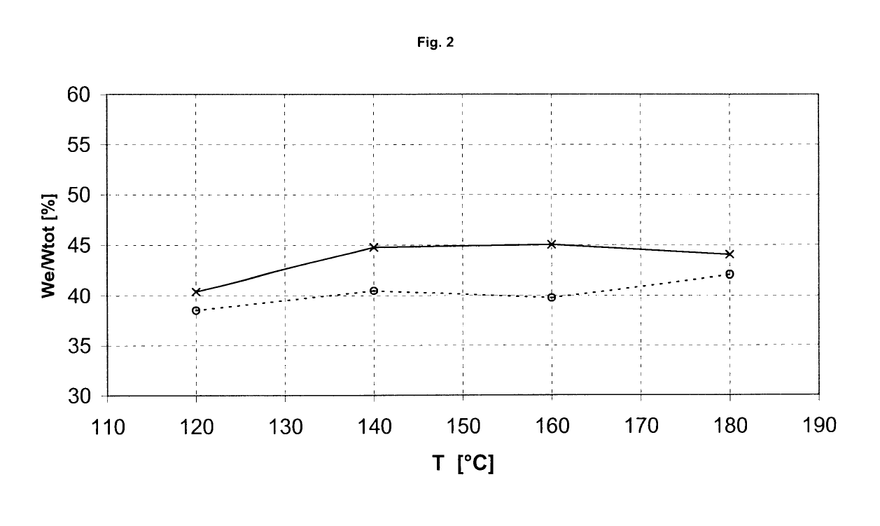

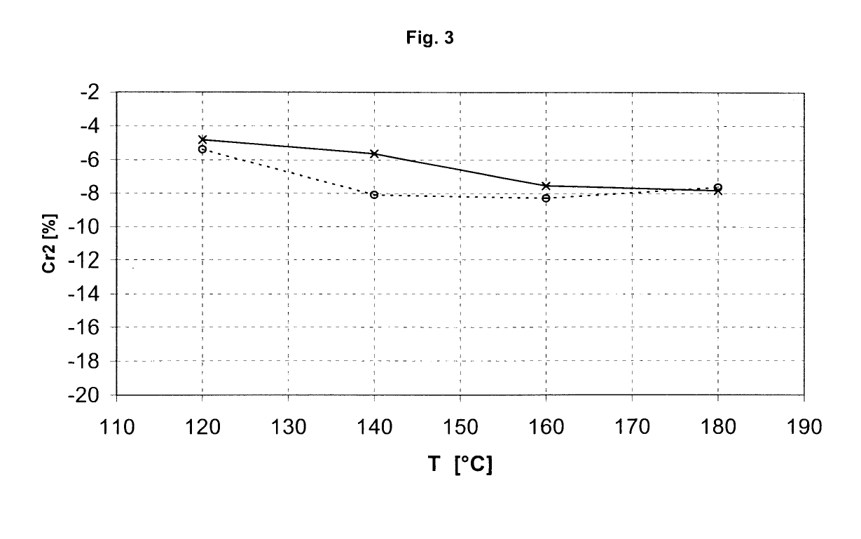

In addition, the mechanical properties of the examples were investigated by Fischer Scope in accordance with DIN 50359, DIN 55676, DIN EN ISO 14577, and VDI/VDE Guideline No. 2616. Parameters determined were the surface hardness (FIG. 1), the elastic resilience (FIG. 2), and the reflow behavior (creep 2, FIG. 3). The measurements were carried out on a Fisherscope H100C instrument with an installed diamond pyramid to measure the Vickers hardness to DIN 50 133. The surface hardness HUc is the corrected universal hardness at the surface (the testing element penetrates only a few micrometers). The result is reported in N/mm². The elastic resilience (Wₑ/Wₜₒₜ, FIG. 3) is the elastic deformation component (hHU) in %, and corresponds to the ratio of elastic deformation energy (Wₑ) to total deformation energy (Wₜₒₜ). The shape correction is always taken into account. The reflow behavior Cr 2 describes the creep under load in %. It describes the behavior of the material at a constant (predetermined) minimum testing force following force reduction. The shape correction is always taken into account. (cf. FIGS. 1-3). In the case of the inventive example, an improvement in all of the abovementioned properties was found as compared with comparative example 1 without carbamate-functional tris(alkoxycarbonyl)aminotriazine. This effect is apparent in particular at baking temperatures of less than 190° C.

Furthermore, an additional comparative example (comparative example 2) was prepared, for which an underivatized tris(alkoxycarbonyl)aminotriazine with mixed butylation and methylation in a 3:1 ratio (product 2) was employed. With the powder coating materials of the invention, for a similar crosslinking temperature, an improved surface is found (no “pinholes” or blistering).

The carbamate-functional powder coating material of the invention, of example 1, therefore exhibits better surface properties than comparable powder coating materials with carbamate-free tris(alkoxycarbonyl)aminotriazine.

| | Comparative | Inventive | Comparative |
|---|---|---|---|
| | example 1 | example 1 | example 2 |
| Crylcoat 1514-2^{[1]} | 492.5 | 431.43 | 443.25 |
| Araldite GT 6063 ES^{[2]} | 492.5 | 431.43 | 443.25 |
| Co-crosslinker | — | 122.14 | 98.5 |
| | | product 1 | product 2 |
| BYK 365 P^{[3]} | 10 | 10 | 10 |
| Benzoin^{[4]} | 5 | 5 | 5 |
| Total [grams] | 1000 | 1000 | 1000 |
| Cross-cut as a function of | | | |
| baking temperature | | | |
| 100° C. | 5 | 5 | |
| 120° C. | 5 | 5 | |
| 130° C. | 1 | 1 | 0 |
| 140° C. | 0 | 0 | 0 |
| 150° C. | 0 | 0 | 0 |
| 160° C. | 0 | 0 | 0 |
| 180° C. | 0 | 0 | 0 |
| MEK test as a function of | | | |
| baking temperature | | | |
| 100° C. | 5 | 5 | |
| 120° C. | 8 | 9 | |
| 130° C. | 30 | >100 | >100 |
| 140° C. | >100 | >100 | >100 |
| 150° C. | >100 | >100 | >100 |
| 160° C. | >100 | >100 | >100 |
| 180° C. | >100 | >100 | >100 |
| Blistering | ++ | ++ | −− |

^{[1]}Crylcoat ® 1514-2 (formerly Crylcoat ® 314) is a carboxylated polyester binder from Cytec (formerly UCB) having an OH number of 3 mg KOH/g, an acid number of 68-74 mg KOH/g, and a glass transition temperature of approximately 55° C., and is used as binder
^{[2]}Araldite ® GT6063 from Huntsman (formerly Vantico) is a solid epoxy resin of the “2½ type” having a molecular weight below 700 g/mol and based on bisphenol A, and acts as a crosslinker. The epoxide number to ISO 3001 is 1.37-1.56 eq/kg, the epoxide equivalent to ISO 3001 is 640-730 g/eq, the viscosity to ISO 12058-1 is 350-500 mPas, and the softening point is 90-97° C.
^{[3]}The film-forming additive BYK 365 P is a polybutyl acrylate with a viscosity of 130-200 mPas and a glass transition temperature of approximately −40° C.
^{[4]}Benzoin serves as a degassing agent.

1. A powder coating material comprising
at least one carboxyl-carrying polyester (A) having a carboxyl group functionality of at least two,
at least one compound (B) having at least two epoxy groups,
optionally, at least one compound (C) having at least two hydroxyl groups, and
at least one tricarbamoyltriazine compound (D), comprising carbamate groups,
said tricarbamoyltriazine compound (D) having a carbamate functionality of at least 2.0 up to 2.95.

2. The powder coating material according to claim 1, wherein the carboxyl-carrying polyester (A) is synthesized from
at least one diol (A1) having a hydroxyl group functionality of 2,
optionally, at least one polyol (A2) having a hydroxyl group functionality of more than 2,
at least one dicarboxylic acid (A3) having a carboxyl group functionality of 2,
optionally, at least one polycarboxylic acid (A4) having a carboxyl group functionality of more than 2, and
optionally, compounds (A5) which contain at least one hydroxyl and/or carboxyl group and at least one functional group different than hydroxyl and carboxyl groups.

3. The powder coating material according to claim 1, wherein the carboxyl-carrying polyester has a glass transition temperature of at least 30° C.

4. The powder coating material according to claim 1, wherein the carboxyl-carrying polyester has an acid number to DIN 53240, Part 2 of more than 0 to 250 mg KOH/g.

5. The powder coating material according to claim 1, wherein component (B) is an aromatic or aliphatic glycidyl ether.

6. The powder coating material according to claim 1, wherein component (D) is composed predominantly of a mixture of compounds (D1) 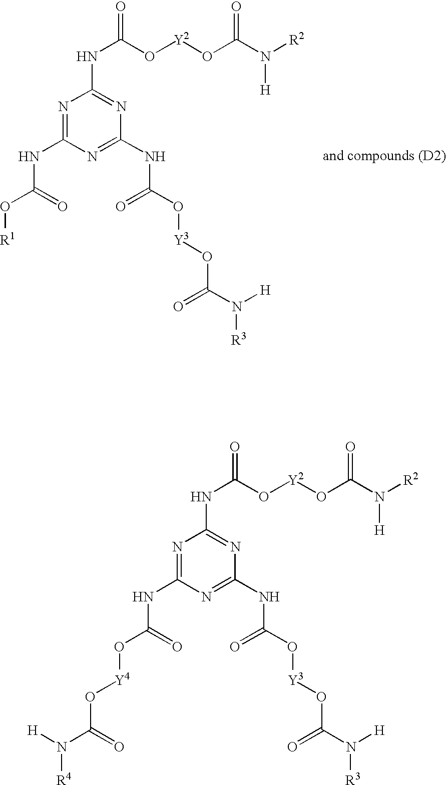
in which
R¹, R², R³, and R⁴ each independently are C₁-C₁₈ alkyl, C₆-C₁₂ aryl or C₅-C₁₂ cycloalkyl,
R², R³, and R⁴ are additionally hydrogen, and
Y², Y³, and Y⁴ each independently are C₂-C₂₀ alkylene, C₅-C₁₂ cycloalkylene, or C₂-C₂₀ alkylene interrupted by one or more oxygen and/or sulfur atoms and/or by one or more substituted or unsubstituted imino groups and/or by one or more cycloalkyl, —(CO)—, —O(CO)O—, —(NH)(CO)O—, —O(CO)(NH)—, —O(CO)— or —(CO)O— groups, it being possible for the stated radicals each to be substituted by aryl, alkyl, aryloxy, alkyloxy, heteroatoms and/or heterocycles.

7. The powder coating material according to claim 6, wherein R², R³, and R⁴ are hydrogen.

8. The powder coating material according to claim 6, wherein Y², Y³, and Y⁴ are 1,2-ethylene, 1,2-propylene, 1,1-dimethyl-1,2-ethylene, 1-hydroxymethyl-1,2-ethylene, 2-hydroxy-1,3-propylene, 1,3-propylene, 1,4-butylene, 1,6-hexylene, 2-methyl-1,3-propylene, 2-ethyl-1,3-propylene, 2,2-dimethyl-1,3-propylene, and 2,2-dimethyl-1,4-butylene, or 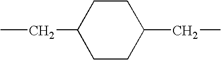
or 1,2-, 1,3- or 1,4-cyclohexylene,

9. A method of coating an article, which comprises applying a powder coating material according to claim 1 to an article and baking it at a substrate temperature below 145° C. over a holding time of 20 minutes to DIN 55990-4.

10. A method of using a powder coating material according to claim 1 to coat an article.
